(19) United States
(12) Patent Application Publication
(10) Pub. No.: US 2007/0070240 A1
(43) Pub. Date: Mar. 29, 2007

(54) CRADLE APPARATUS, TERMINAL APPARATUS, AND CAMERA CONTROL SYSTEM AND METHOD THEREFOR

(76) Inventor: Takashi Oya, Yokohama-shi (JP)

Correspondence Address: MORGAN & FINNEGAN, L.L.P., 3 WORLD FINANCIAL CENTER, NEW YORK, NY, 10281-2101, US

(21) Appl. No.: 11/534,856

(22) Filed: Sep. 25, 2006

(30) Foreign Application Priority Data
Sep. 26, 2005 (JP) 2005-278784

(51) Int. Cl. H04N 5/225

(52) U.S. Cl. 348/375

(57) ABSTRACT

Operation modes of a camera apparatus and a cradle apparatus are acquired, and an application to be executed on a terminal apparatus is automatically determined and launched according to the acquired operation modes.

### BACKGROUND OF THE INVENTION

1. Field of the Invention

The present invention relates to a cradle apparatus which fixes an image sensing apparatus, a terminal apparatus connected to the cradle apparatus via a network to perform photographing or displaying of images, and a camera control system comprising such apparatuses and a method therefor.

2. Description of the Related Art

It has become popular to connect a digital camera to a computer and remotely operate the digital camera to perform photographing, or transferring images photographed by the digital camera to the computer to manage the images. The applicant has developed a digital camera platform, referred to as a cradle, which is equipped with functions for supplying electric power and connecting to a computer. This cradle is described in Japanese Patent Laid-Open No. 2002-199251 as a cradle equipped with pan/tilt functions.

The functions of a digital camera may be divided broadly into capturing still images (taking a picture), capturing moving images (recording a video image), and playback of images. On the other hand, there is a wide variety of application software which runs on computers and other operation terminals connected to digital cameras. Such application software includes those for remote capturing, acquirement of photographed images, image management, printout, television conferencing, monitoring and the like. In order to use such software, a digital camera is first switched to a connection mode to establish connection with a computer. Typically, an application is subsequently launched at the computer side.

It is envisioned that a user will feel it to be troublesome to additionally select an application to be launched at the computer side in a state where modes such as playback and photographing are preset for the digital camera.

### SUMMARY OF THE INVENTION

An object of the present invention is to overcome the above problem in conventional art.

In consideration of such situations, a feature of the present invention is to determine an application to run on a terminal apparatus according to operation modes of a cradle apparatus and an image sensing apparatus without troubling a user.

According to the present invention, there is provided a cradle apparatus having a mount member for mounting an image sensing apparatus, a control unit for controlling the image sensing apparatus mounted on the mount member, and a communication unit for communicating with a terminal apparatus, the cradle apparatus comprising:

a mode acquisition unit configured to acquire an operation mode of the image sensing apparatus; and

a notification unit configured to notify an operation mode of the image sensing apparatus acquired by the mode acquisition unit and information related to an application to be executed in a terminal apparatus, selected at the cradle apparatus to the terminal apparatus.

According to the present invention, there is provided a terminal apparatus for communicating with a cradle apparatus for mounting an image sensing apparatus, the terminal apparatus comprising:

a mode acquisition unit configured to acquire an operation mode of the image sensing apparatus from the cradle apparatus; and

a determination unit configured to determine an operation of an application to be executed, according to the operation mode acquired by the acquisition unit.

Further, according to the present invention, there is provided a camera control system having a camera, a cradle apparatus for mounting the camera, and a terminal apparatus which communicates with the cradle apparatus, the camera control system comprising:

an acquisition unit configured to acquire at the cradle apparatus an operation mode of a camera mounted on the cradle apparatus and information related to an application to be executed in a terminal apparatus, selected at the cradle apparatus;

a notification unit configured to notify the operation mode of the camera and the information acquired by the acquisition unit to the terminal apparatus; and

a launching unit configured to determine an operation of an application to be launched on the terminal apparatus and launch the application according to the operation mode of the camera mounted onto the cradle apparatus and the information notified by the notification unit.

Further features of the present invention will become apparent from the following description of exemplary embodiments with reference to the attached drawings.

### BRIEF DESCRIPTION OF THE DRAWINGS

FIG. 1 is a diagram for explaining a configuration of a camera system according to an embodiment of the present invention;

FIGS. 2A and 2B are diagrams for explaining a mode selection switch for selecting a mode of a camera according to the present embodiment;

FIG. 3 is a block diagram for explaining a functional configuration of hardware of a camera and a cradle according to the present embodiment;

FIG. 4 is a block diagram for explaining a software configuration of a camera system according to the present embodiment;

FIG. 5 is a diagram for explaining combinations of modes of a camera and a cradle, and selection of an application according to the present embodiment;

FIG. 6A is a diagram showing an operation procedure and a communication procedure of software modules respectively operating on the devices of a camera, a cradle and a viewer according to the present embodiment; FIG. 6B is a diagram showing an example of a SOAP response;

FIG. 7 is a diagram showing an operation procedure and a communication procedure of software modules respectively operating on the devices of a camera, a cradle and a viewer according to a second embodiment;

FIG. 8 is a diagram showing an operation procedure and a communication procedure of software modules respectively operating on the devices of a camera, a cradle and a viewer according to a third embodiment;

FIG. 9A is a block diagram for explaining a software configuration of a camera system according to a fourth embodiment;

FIG. 9B is a diagram for explaining information necessary at the application-side;

FIG. 10 is a diagram showing an operation procedure and a communication procedure of software modules respectively operating on the devices of a camera, a cradle and a viewer according to the fourth embodiment;

FIG. 11A is a block diagram for explaining a software configuration of a camera system according to a fifth embodiment; and

FIG. 11B is a diagram for explaining an example of information transmitted from a cradle to an application.

### DESCRIPTION OF THE EMBODIMENTS

Preferred embodiments of the present invention will be described in detail with reference to the accompanying drawings. It should be noted that the embodiments below do not limit the present invention set forth in the claims and that all combinations of features described in the embodiments are not necessarily essential as means for attaining the objects of the invention.

In the present embodiment, an application to be executed on an operation terminal (in this case, a viewer or PC and the like) is determined by a combination of mode selection of a digital camera, which is an image sensing apparatus, and application selection of a cradle. By arranging the application to be automatically launched in the operation terminal, troublesome operations from the launch of the application at the operation terminal to realization of a desired state may be omitted. In the following description, operation terminals will be referred to as viewers. In addition, digital cameras will simply be referred to as cameras.

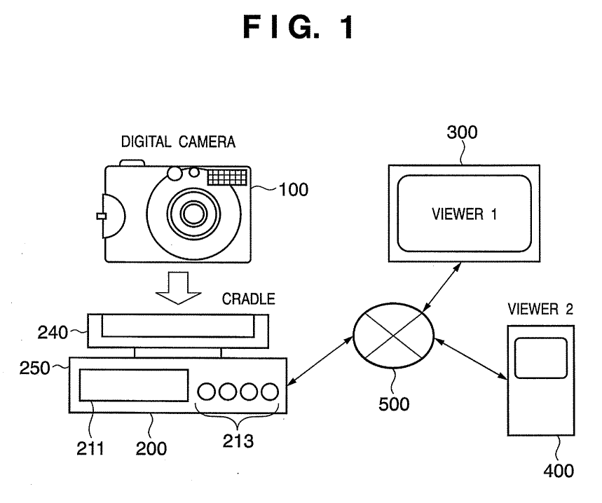

FIG. 1 is a diagram for explaining a configuration of a camera system according to an embodiment of the present invention.

The camera system comprises a camera 100, a cradle 200, and viewers 300 and 400. The cradle 200 and the viewers 300 and 400 are mutually communicable via a network 500. The camera system can be also applicable to a configuration which does not go though the network 500. At the camera 100, changing camera parameters such as zoom, focus, exposure and shutter speed, as well as release operations and retrieving or deleting photographed images may be controlled externally. Control instructions for such operations may be issued from the cradle 200 to the camera 100, in a case that the camera 100 is connected with the cradle 200.

The cradle 200 comprises a pan/tilt head 240 and a main body 250. Buttons 213 to be used to select applications are arranged on the main body 250 of the cradle 200. The camera 100 is mountable on the pan/tilt head 240, which is equipped with a locking mechanism (not shown) for detection of mounting of the camera 100 and for fixing the camera 100. While the camera 100 is mounted onto the pan/tilt head 240, an electric power is supplied from the cradle 200 to the camera 100 via a connecter attached to the head 240. Control signals for the camera 100 are also transmitted and received through this connector.

Applications are running on the viewers 300 and 400. The viewers 300 and 400 may include a computer (PC), a PDA (personal digital assistant), a cellular phone or the like. It is also possible to simultaneously connect a plurality of viewers to the single cradle 200. Applications for remote capturing (image sensing processing through remote operation), viewing photographed images, video conferencing, self portrait, monitoring and the like run on the viewers 300 and 400.

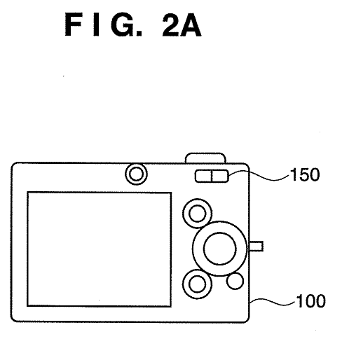

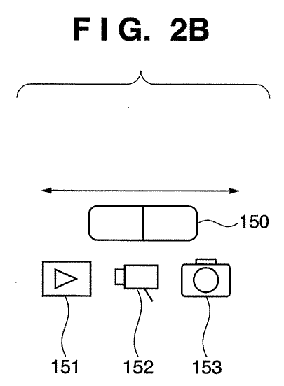

FIGS. 2A and 2B are diagrams for explaining a mode selection switch of the camera 100 for selecting an operation mode of the camera 100 according to the present embodiment.

As shown in FIG. 2A, a mode selection switch 150 is located on the rear face of the camera 100, and is horizontally slidable so as to select a desired mode.

FIG. 2B depicts an enlarged view of the mode selection switch portion. Operation modes may be selected by sliding the switch 150 to the positions indicated by icons 151 to 153, which are printed onto a rear surface of the camera 100, to select a mode. Operation modes of the camera 100 include playback 151, capturing moving images 152, capturing still images 153 and the like.

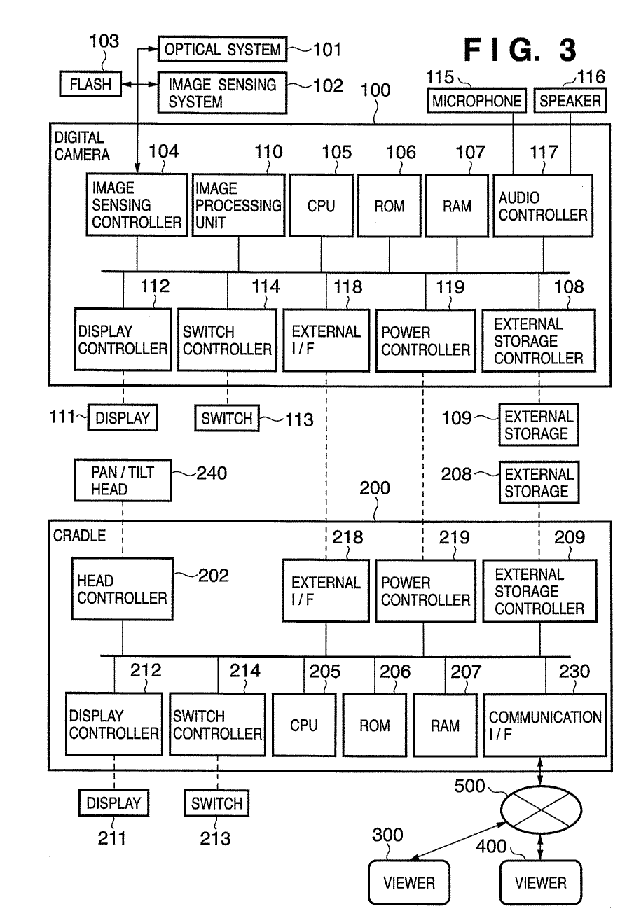

FIG. 3 is a block diagram for explaining a functional configuration of hardware of the camera 100 and the cradle 200 according to the present embodiment.

The camera 100 comprises an optical system 101, an image sensing system 102, a flash 103, an image sensing controller 104, an image processing unit 110, an external storage controller 108, and an external storage 109 such as a memory card. The camera 100 further comprises a display controller 112, a display 111, a switch controller 114, switches 113, a microphone 115, a speaker 116, an audio controller 117, an external I/F 118, and a power controller 119. The camera 100 further comprises a CPU 105, a ROM 106, and a RAM 107. The switches 113 include a release button, a cursor key, and the like.

The optical system 101 has a lens and a driving motor. The image sensing system 102 has an image sensing device such as a CCD, a CMOS or the like, and a control circuit therefor. The optical system 101 and the image sensing system 102 are controlled by the image sensing controller 104, together with the flash 103 and the like. Photographed images are compressed by the image processing unit 110 to a predetermined size in a format such as JPEG, Motion JPEG, MPEG4 or the like, and are stored in the RAM 107 or the external storage 109. Photography is performed while viewing images displayed on the display 111 by using any of the switches 113 to set various parameters and photography modes, and finally by pressing the release button of the switches 113. It is also possible to verify subjects using an optical finder (not shown). In addition, when capturing moving images, sound is recorded through the microphone 115. A memory card such as a SD card or a CF (CompactFlash®) card is used as the external storage 109 to store photographed images.

The external I/F 118 is used for communicating with external devices, and enables various operations which accompany photography such as photographing instructions, as well as operations such as reading out photographed images and initializing memory cards to be performed from the cradle 200. USBs (Universal serial buses) are commonly used as the interface of the external I/F 118. The power controller 119 receives electric power supplied from the cradle 200, and is capable of turning the camera 100 on or off from the outside thereof. An electric power line and the USB or the like are connected through connectors (not shown). The CPU 105 is responsible for overall control of the above-described units, while the ROM 106 stores a program to be implemented by the CPU 105 and data for setting values and the RAM 107 provides a work area to store several data. It is assumed that the camera 100 is provided with an ID for individual recognition.

The cradle unit 200 comprises the pan/tilt head 240, a head controller 202, an external storage controller 209, an external storage 208, a display 211, a display controller 212, a communication I/F 230, an external I/F 218, a power controller 219, a CPU 205, a ROM 206, and a RAM 207. The camera 100 is mounted onto the pan/tilt head 240 which changes the attitude of the mounted camera 100 using a pan motor and a tilt motor. The display 211 has a compact size. Designation of applications to be launched on the viewers 300 and 400, as well as various settings, may be performed using a GUI displayed on the display 211 together with the buttons 213. The external I/F 218 is used for communicating with the camera 100. Such communication includes transmitting camera control requests from the viewers 300 and 400 to the camera 100 and transferring image data from the camera 100 to the cradle 200. Since the main body size of the cradle 200 is larger than that of the camera 100, a large-capacity HDD or the like may be employed as the external storage 208. The use of the large-capacity HDD enables storage of images received from the camera 100 in large quantities.

The power controller 219 supplies electric power to the camera 100, and is capable of controlling turning on/off of the camera 100. The communication I/F 230 is used for communicating with a network 500, and communicates with the viewer 300 or 400 via the network 500.

The cradle 200 analyzes requests issued by the viewer 300 or 400 to the cradle 200 or the camera 100, and when necessary, transmits instructions to the camera 100. The CPU 205 performs overall control of the cradle 200. Pluralities of cradles 200 and viewers 300, 400 may be connected to the network 500. The present embodiment assumes that TCP/IP is used for the network 500. However, the network 500 need not rely on a particular protocol, as long as sufficient capacity is provided for transmitting control signals for the cradle 200 or the camera 100 and for transmitting compressed video signals. In addition, while a plurality of forms of physical connection such as wired and wireless systems exist, the network 500 need not rely on these forms. Moreover, a form in which the cradle 200 and the viewers are connected by USB or the like without going through the network 500 may also be contemplated.

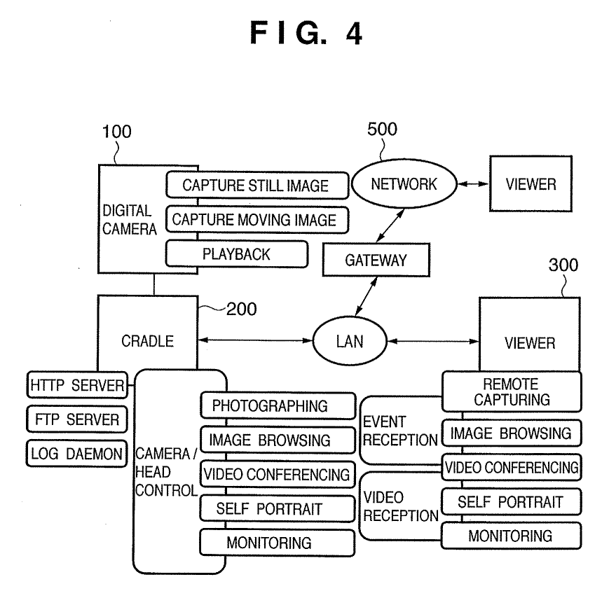

FIG. 4 is a block diagram for explaining a software function configuration of a camera system according to the present embodiment.

The camera 100 may be set to any of three operation modes, namely: “capturing still image”, “capturing moving image” and “playback”. A different process will be executed for each mode. A multi-process OS runs on the cradle 200. As a result, control processes for the camera 100 and the head 240 run simultaneously with processes which execute functions of an HTTP server, an FTP server, a LOG daemon or the like. A thread corresponding to an application running on the viewer 300 runs in the control processes for the camera 100 and the head 240. Applications to run on the viewer 300 include those for remote capturing, image browsing, video conferencing, self portrait, and monitoring or the like.

Applications run on the viewers 300 and 400. While applications are respectively launched and terminated as separate processes, cross-application processes such as those for receiving videos or events and the like run constantly. In this case, the communication protocol between the cradle 200 and the viewers 300 and 400 is implemented on TCP or HTTP. Methods for controlling the camera 100 using TCP or HTTP are employed in, for instance, network camera products and the like.

In the present embodiment described below, a case of selecting operation of an application to be launched on the viewer 300 according to a combination of a mode selection of the camera 100 and a viewer application selection at the cradle 200 will be described. Since a case using the viewer 400 may be executed using the same procedure as for the viewer 300, a description thereof will be omitted.

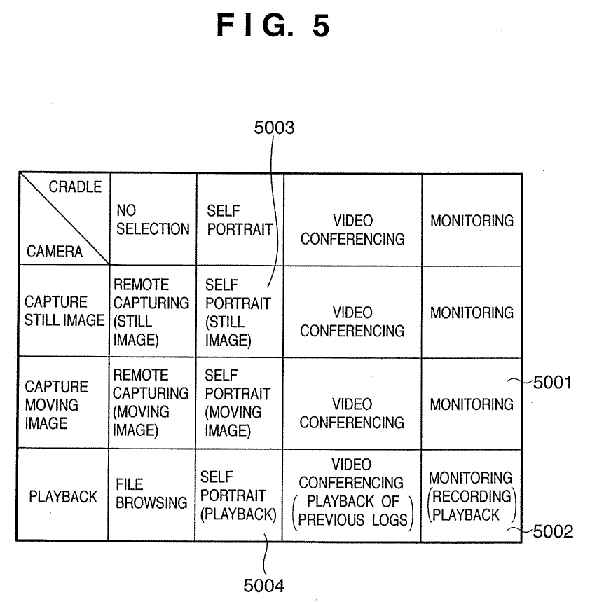

FIG. 5 is a diagram for explaining combinations of modes of the camera 100 and the cradle 200, and selection of an application of the viewer 300, in a camera system according to the present embodiment.

In FIG. 5, horizontal fields indicate items to be selected by the application selection button 213 of the cradle 200, while vertical fields indicate modes which are selectable by the mode selection switch 150 of the camera 100. Application selection items of the cradle 200 include the four items of “self portrait”, “video conferencing”, “monitoring”, and “no selection”. Selection items of the operation mode of the camera 100 include the three items of “capturing still images”, “capturing moving images” and “playback”.

For the present invention, “remote capturing” is assumed to be an application with a function that enables remote control of the camera 100 from the viewer 300, which sets photographing parameters such as pan, tilt, and zoom or the like, and takes pictures or records videos.

In addition, “file browsing” is a function to playback photographed image files accumulated in the cradle 200, from the viewer 300.

Furthermore, “self portrait” is assumed to be an application in which a self portrait is photographed by positioning the camera in front of the photographer. This application is equipped with a function for compositing an image frame to be used for decorating a photographed image, and a function for assisting adjustment of photographing positions by superimposing a pointer on a displayed video acquired from the camera 101 prior to capturing still images.

Moreover, “video conferencing” is assumed to be an application for transmission and reception of video and audio with a remote location.

In addition, “monitoring” is assumed to be an application which is equipped with a function for detecting movement of a subject based on videos acquired from the camera 100. This application is also equipped with a function to accumulate images according to detection of movement of an intruder or the like. The application is further equipped with a function to playback such accumulated images.

Assume now that, for instance, the “capturing moving image” mode has been selected for the camera 100 and “monitoring” has been selected at the cradle 200, and that the cradle 200 has been turned on. In this case (5001), the viewer 300 will be activated in a state in which the “monitoring” application is displaying a live image photographed by the camera 100.

Similarly, when the “monitoring” application is selected at the cradle 200, if the camera 100 is in “playback” mode, a screen of the “monitoring” application for performing “recording playback” operations will be activated on the viewer 300 (5002).

In addition, when the “self portrait” application is selected at the cradle 200, if the camera 100 is in “capturing still image” mode, the “self portrait” application will be automatically launched on the viewer 300 (5003). Furthermore, when the “self portrait” application is selected at the cradle 200 but the camera 100 is in “playback” mode, the “self portrait” application will be launched on the viewer 300 and the mode will transit to a “playback” mode in order to playback previously photographed self portrait images (5004).

Moreover, when the application selection button 213 of the cradle 200 is set to “no selection”, the “remote capturing (pictures, videos)” application or the “file browsing” application will be launched according to the operation mode of the camera 100. These applications provide basic functions. In this case, the application to be launched on the viewer 300 is solely dependent on the operation mode of the camera 100.

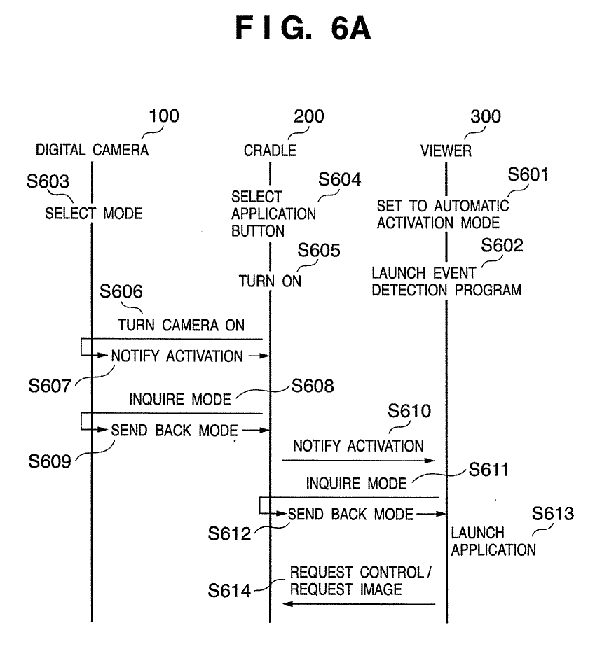

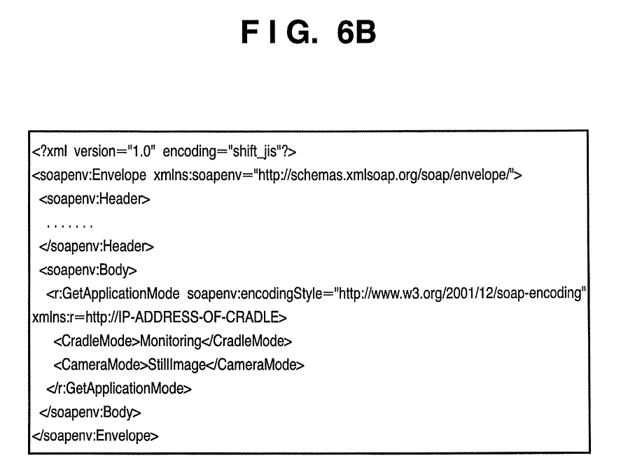

A procedure of automatic launch of an application according to the present embodiment will now be described with reference to FIG. 6A.

FIG. 6A is a diagram showing an operation procedure and a communication procedure of software modules respectively operating on the devices of the camera 100, the cradle 200 and the viewer 300 according to the present embodiment. FIG. 6A shows a case where activation is performed in the sequence of viewer 300, cradle 200, and camera 100. Assume now that the viewer 300 is activated first. The viewer 300 is arranged to set in advance whether applications will be automatically launched, and to store the setting state. In FIG. 6A, the viewer 300 stores the setting of automatic activation mode in step S601. In step S602, the viewer 300 launches a process for receiving events from the cradle 200.

Meanwhile, in step S603, a user selects an operation mode for the camera 100. In addition, in step S604, the user selects an application for the cradle 200. The user then mounts the camera 100 on the cradle 200, and in step S605 turns on the cradle 200. This allows turning on/off of the camera 100 to be controlled from the cradle 200, as described earlier. In step S606, once mounting of the camera 100 onto the cradle 200 is detected, the cradle 200 turns the camera 100 on. In response, an activation notification is sent back from the camera 100 in step S607. In step S608, an inquiry is forwarded from the cradle 200 to the camera 100 as to which operation mode was assumed by the camera 100 upon activation. In step S609, in response to the operation mode inquiry, the camera 100 sends back information regarding the selected operation mode of the camera 100. It is also possible to connect the camera 100 after turning on the same, and then turning on the cradle 200. In this case, the steps S606 and S607 will no longer be required.

In step S610, the cradle 200 notifies an activation event to the viewer 300. One method of event notification involves transmitting packets from the cradle 200 to a broadcast address. In contrast, another method involves regularly transmitting packets from the viewer 300 to a broadcast address, and replying from the cradle 200 upon detection of such packets. In addition, it is also possible to use the discovery mechanism of UPnP (Universal Plug and Play).

After confirming activation of the cradle 200, in step S611, the viewer 300 forwards a mode inquiry to the cradle 200. In response, in step S612, the cradle 200 sends back contents of the application selected for the cradle 200 and information regarding the operation mode of the camera 100 to the viewer 300. Protocols for requesting and responding include a method using the SOAP framework.

FIG. 6B is a diagram showing an example of a response using SOAP, and indicates that the mode of the camera 100 is “capturing still image” mode and the application selected for the cradle 200 is “monitoring”. Upon receiving the response, in step S613, the viewer 300 launches a predetermined application (in the example shown in FIG. 5, the “monitoring” application) in a predetermined mode, in accordance with the correspondence shown in FIG. 5. Subsequently, in step S614, operation of the application is continued by controlling the camera 100 through the GUI of the application or issuing requests for image acquisition.

As described above, according to the first embodiment, an application to be launched on the viewer 300 can be selected by a combination of designation of an operation mode of the camera 100 with a selection of an application of the cradle 200. This enables automatic launch of a desired application in a desired state, thereby simplifying operations regarding application selection or the launch of the application.

### Second Embodiment

A second embodiment of the present invention will now be described. For the second embodiment, an example will be described in which the cradle 200 is activated first, and then followed by activation of the camera 100. In the first embodiment, both the camera 100 and the cradle 200 were already activated upon activation notification (S610) from the cradle 200 to the viewer 300. In contrast, the second embodiment differs from the first embodiment in that only the prior activation of the cradle 200 is notified to the viewer 300. The second embodiment only differs from the first embodiment in its operation procedure, and the hardware configuration of the devices is the same. Therefore, a description thereof will be omitted.

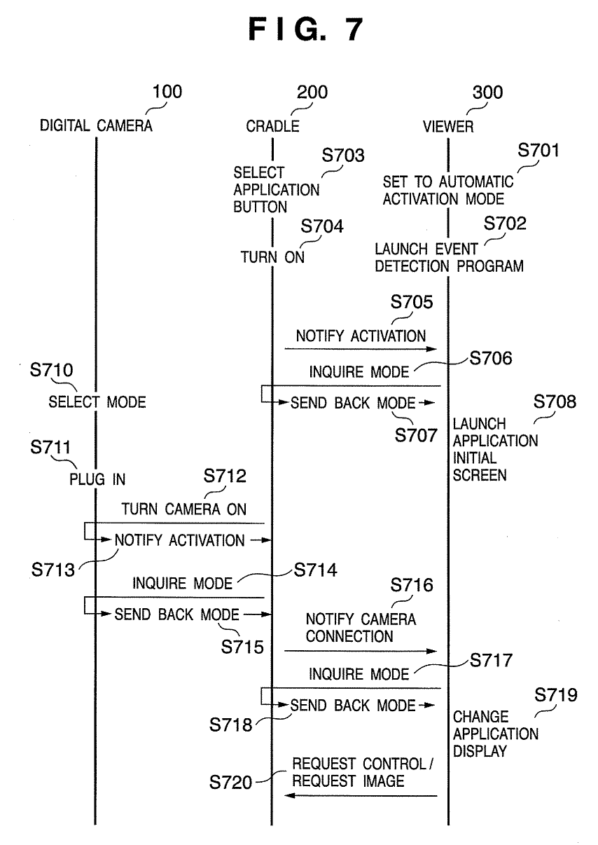

FIG. 7 is a diagram showing an operation procedure and a communication procedure of software modules respectively operating on the devices of the camera 100, the cradle 200 and the viewer 300 according to the second embodiment.

First, in step S701, the viewer 300 is activated. It is assumed that activation of applications on the viewer 300 is set to “automatic activation” mode in the same manner as in the first embodiment. In step S702, an activation detection program is launched.

After then the cradle 200 is activated. In step S703, an application button 213 of the cradle 200 is selected by the user. In step S704, the cradle 200 is turned on. This causes the cradle 200 to send a notification of activation in step S705 to the viewer 300. Next, in steps S706 and S707, an application selection state of the cradle 200 is verified by a method similar to the above-described first embodiment. Since the camera 100 is not connected to the cradle 200 at this point, the operation mode of the camera 100 cannot be verified through the cradle 200. Therefore, in step S708, the viewer 300 stands by in an application initial state, or in other words, a state in which the application designated by the cradle 200 is launched but connection to the camera 100 is not performed. However, functions which do not require connection with the camera 100, such as viewing of images of the cradle 200 using the “file browsing” application, have transited from their initial states and are usable. In addition, in the event that the application selected for the cradle 200 is “no selection”, since it is uncertain which application should be launched, an application launcher screen is displayed. In the procedure thus far, the function of the application of the viewer 300 is determined by detection of application selection at the cradle 200.

Subsequently, in step S710, a user sets an operation mode of the camera 100. In step S711, the camera 100 is connected to the cradle 200. This causes the cradle 200 to detect physical contact with the camera 100. In step S712, the cradle 200 issues an instruction to turn on the camera 100. After receiving this instruction, the camera 100 turns on, and in step S713, notifies activation to the cradle 200. In step S714, an inquiry regarding activation mode is forwarded from the cradle 200 to the camera 100. Once the camera 100 responds to the inquiry in step S715, the cradle 200 notifies the viewer 300 in step S716 that the camera 100 has been connected and activated.

This enables the viewer 300 to immediately detect activation of the camera 100 through an event detection process. In step S717, an inquiry regarding operation mode of the camera 100 is once again forwarded to the cradle 200. In step S718, the cradle 200 sends back the operation mode of the camera 100 and application selection information of the cradle 200. Upon reception thereof, if there is a running application, the viewer 300 changes the display of the application in step S719. In step S720, the viewer 300 forwards a control request for the camera 100 and an image request to the cradle 200. This allows viewing of videos of the camera 100 in addition to those of the cradle 200, for instance in the event that the “file browsing” application is running on the viewer 300. In addition, when the “monitoring” application is running, acquisition of videos from the camera 100 is initiated. On the other hand, if there are no running applications, an application determined according to the operation mode of the camera 100 is launched in a similar fashion to the above-described first embodiment.

As described above, according to the second embodiment, applications of the viewer 300 may be automatically launched even in the event that the cradle 200 is connected to the camera 100 after activation of the cradle 200. This enables procedures for application operation of the viewer 300 to be simplified.

### Third Embodiment

Next, as a third embodiment of the present invention, an example will be described for a case in which an application of the viewer 300 is first launched, followed by activation of the cradle 200 and the camera 100, wherein operations of the cradle 200 and the camera 100 are selected according to the type or state of the launched application. The hardware configuration and software configuration according to the third embodiment are the same as those of the above-mentioned first embodiment, and therefore will not be described hereunder. Instead, the description will focus on operation procedures.

Operations of the viewer 300, the cradle 200 and the camera 100 according to the third embodiment are as outlined below. For instance, assume that the “self portrait” application has been launched on the viewer 300, and the “capturing still image” mode has been set. According to FIG. 5, the corresponding operation states of the cradle 200 and the camera 100 are, respectively, selection of the “self portrait” application at the cradle 200 and the “capturing still image” operation mode of the camera 100. However, since neither the cradle 200 nor the camera 100 have been activated, pictures cannot be taken. In this case, by activating and connecting the cradle 200 to the camera 100, the application state of the viewer 300 is transmitted to the cradle 200 and the camera 100. As a result, an operation will take place so that the mode of the cradle 200 transits to “self portrait” application, while the operation mode of the camera 100 transits to the “capturing still images” mode.

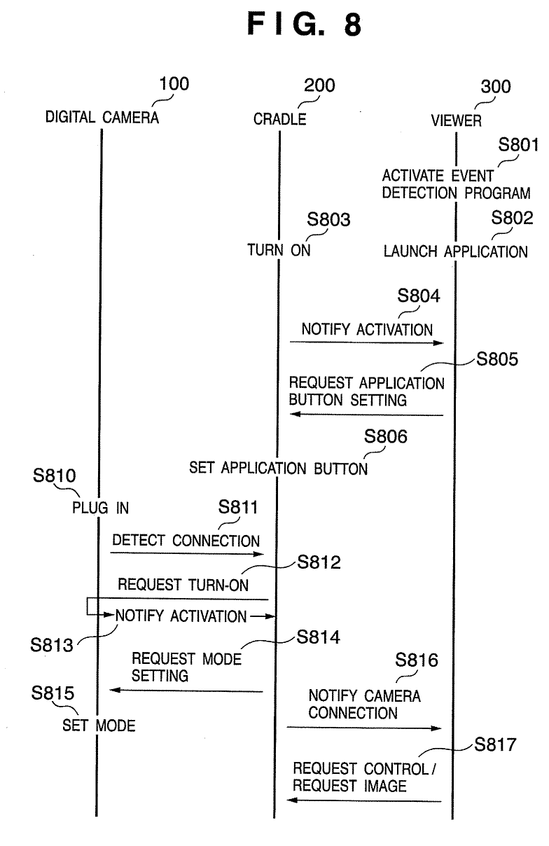

FIG. 8 is a diagram showing an operation procedure and a communication procedure of software modules respectively operating on the devices of the camera 100, the cradle 200 and the viewer 300 according to the third embodiment. Similar to FIGS. 6A and 7, FIG. 8 is a diagram which shows a process of communication between the camera 100, the cradle 200 and the viewer 300, in which the cradle 200 and the viewer 300 are connected via a network such as a LAN. In addition, it is assumed that the camera 100 and the cradle 200 communicate through serial connection such as USB.

First, in step S801, the viewer 300 is activated, which in turn launches an event detection process. Upon activation, the viewer 300 displays an application selection screen (not shown). In step S802, the user launches an application for the viewer 300. In addition, the viewer 300 assumes a predetermined state such as a screen for acquiring pictures. As already described, the cradle 200 is not yet connected with the camera 100 at this point. In step S803, the user turns on the cradle 200 in this state. This causes notification of activation in step S804 from the cradle 200 to the viewer 300. After confirming activation of the cradle 200, in step S805, the viewer 300 issues a control request for the buttons 213 on the cradle 200. As described earlier in the first embodiment, the buttons 213 are positioned on the cradle 200, and are used to select an application to run on the cradle 200. Upon receiving this request, any one of the buttons 213 is set in step S806. It is needless to say that the objects of the setting are not limited to this button.

Next, in step S810, the camera 100 is physically connected to the cradle 200. A switch for detecting physical connections of the camera 100 is provided on the cradle 200. This enables detection of the connection with the camera 100 in step S811. In step S812, the cradle 200 requests the camera 100 to be turned on. In step S813, notification of activation of the camera 100 is forwarded from the camera 100 to the cradle 200. An operation for turning on the camera 100 is performed by controlling the power switch from the cradle 200. Once the camera 100 is turned on in this manner, communication is established between the cradle 200 and the camera 100, and notification of activation is forwarded through, for instance, USB or the like. At this point, since the state of an application running on the viewer 300 has already been verified by the cradle 200, in step S814, a mode setting request is issued from the cradle 200 to the camera 100 so that a corresponding mode is set at the camera 100. In this manner, in step S815, the camera 100 is set to the designated operation mode.

Meanwhile, after transmitting an operation mode setting request to the camera 100 in step S814, the cradle 200 notifies the viewer 300 in step S816 that connection to the camera 100 has been made. This enables the application to become aware of the camera 100 being connected to the cradle 200. In step S817, the application of the viewer 300 issues various control requests or image requests to the cradle 200 or the camera 100. In response, the cradle 200 or the camera 100 performs corresponding operations. However, a description thereof will be omitted.

As described above, according to the third embodiment, the viewer 300 may reflect an operation state of its own application in the operation states of the subsequently activated cradle 200 or camera 100. Since the subsequently activated cradle 200 or camera 100 may be set to modes corresponding to the application of the viewer 300 while omitting operation of the buttons 213 or switches 113 on the cradle 200 or the camera 100, improvement of usability may be achieved.

### Fourth Embodiment

A fourth embodiment of the present invention will now be described. The fourth embodiment is characterized in that by connecting the camera 100 to the cradle 200 in a state in which an image is displayed on the camera 100, a corresponding application is automatically launched on the viewer 300. The “self portrait” application will now be described as an example. The “self portrait” application is a mode for photographing a portrait image, and includes functions for superimposing a photographed image on a frame to be printed and for transmitting the photographed image as attachments to e-mails. The hardware configuration of the devices according to the fourth embodiment is the same as that of the above-mentioned first embodiment, and therefore will not be described hereunder. Instead, the description will focus on software configuration and operation procedures.

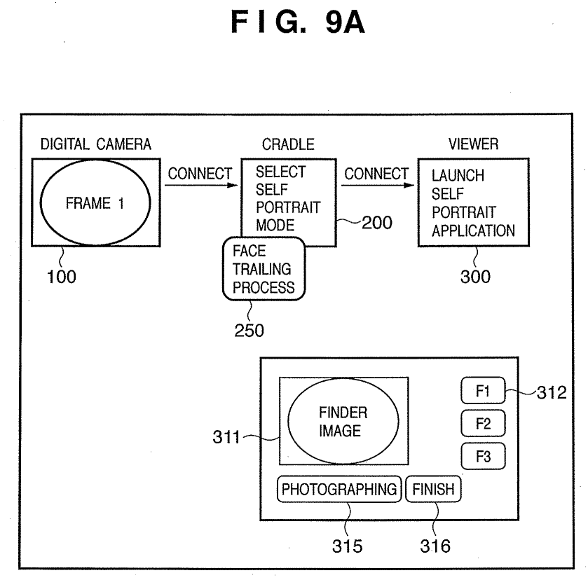

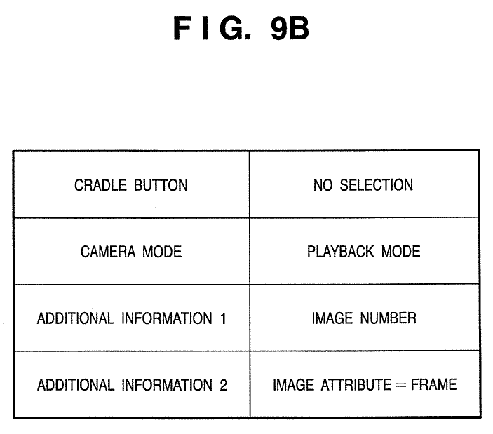

FIG. 9A is a block diagram for explaining a software configuration of a camera system according to the fourth embodiment.

In this case, the camera 100 is activated and set to playback mode, and connected to the cradle 200 in a state in which a desired frame image is selected. The frame image is associated with the “self portrait” application. The cradle 200 next enters a “self portrait” mode to launch a face trailing process 250. Since the cradle 200 notifies the viewer 300 that the camera 100 has been connected in “self portrait” mode, the viewer 300 launches the “self portrait” application. When a frame image is acquired from the camera 100, the “self portrait” application controls the camera 100 to assume “capturing still image” mode to display a finder image. When a release instruction is issued by the user, the “self portrait” application photographs and acquires a picture, and superimposes the image onto a frame image for display. Subsequently, printout or the like is performed.

An important point here is that the image displayed on the camera 100 determines operations of the cradle 200 and the viewer 300. In other words, the selected image is recognized as being a frame image for “self portrait”, and the cradle 200 enters its “self portrait” mode and executes a face trailing process. In addition, the viewer 300 does not merely launch a “self portrait” application, but also automatically acquires the frame image from the camera 100 and displays the image.

FIG. 9B is a diagram for explaining information required in this operation by the application of the viewer 300.

The application selected for the cradle 200 is either “no selection” or “self portrait”, while the operation mode of the camera 100 is “playback” mode. An image number and image attribute selected by the camera 100 are respectively provided as additional information 1 and 2. The information is transmitted from the cradle 200 to the application of the viewer 300 upon activation of the cradle 200. The information may be transmitted using a SOAP framework, as described earlier in the first embodiment.

It can be recorded as header information that an image designated by the camera is an image of “self portrait”. For example, an adequate code may be attached after an APP0 marker of a JPEG format so that the image is indicated as a frame image of “self portrait”. For another example, a file name of the frame image may be started “frm” or an extension “.frm” of a file name of the frame image may be added in order to indicate that the image is an image of “self portrait”. Further, it may be determined that all images stored in a predetermined folder are images of “self portrait”.

Furthermore, it can be determined that the image is the frame image with reference to a list file describing a set of frame images or an index file describing an attributes of image. In this case, it is necessary to designate that an image file includes a frame image using an application after capturing an image. A format of attribute information exchanged between the viewer and the cradle may be a format shown as in FIG. 9B.

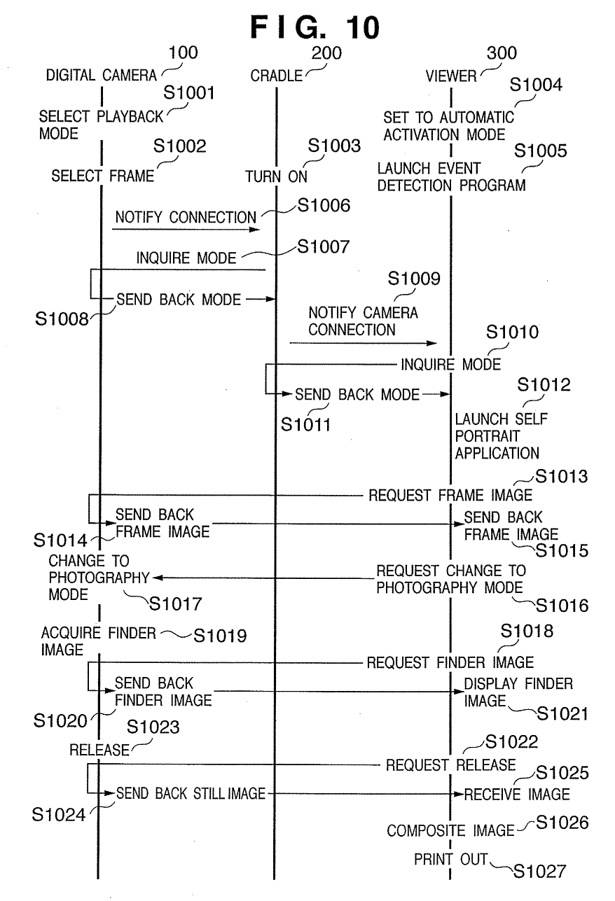

An operation procedure and communication procedure will now be respectively described in detail for each process of the cradle 200 and the viewer 300 with reference to FIG. 10.

FIG. 10 is a diagram showing an operation procedure and a communication procedure of software modules respectively operating on the devices of the camera 100, the cradle 200 and the viewer 300 according to the fourth embodiment.

First, in step S1001, the camera 100 is activated and then set to “playback” mode. In step S1002, a desired frame image is selected and displayed on the display of the camera 100. It is assumed that information to the effect that the image is a frame image for “self portrait” is written in the header information of the frame image. In step S1003, the cradle 200 is turned on. In addition, the viewer 300 is also turned on in step S1004, and an automatic activation mode has been selected in the viewer 300. In step S1005, an event detection program is launched to detect an event sent from the cradle 200.

The camera 100 is then connected to the cradle 200 in a state in which the frame image is displayed at the camera 100. This enables the cradle 200 to detect the connection of the camera 100 in step S1006. In step S1007, the cradle 200 forwards an inquiry regarding operation mode to the camera 100. In step S1008, notification is forwarded from the camera 100 to the cradle 200 to the effect that the frame image displayed in “playback” mode is a frame image for “self portrait”, and that sub-information is “self portrait” mode. This allows the cradle 200 to notify the viewer 300 in step S1009 that the camera 100 has been connected to the cradle 200. While the viewer 300 changes its operations when notified by the cradle 200 that the camera 100 has been connected in the second embodiment described earlier, a description of this operation will be omitted for the fourth embodiment.

Upon notification of the connection of the camera 100, in step S1010, the viewer 300 forwards an inquiry regarding operation mode to the cradle 200. As a result, in step S1011, a notification is forwarded from the cradle 200 to the viewer 300 to the effect that the camera 100 has been activated in “playback” mode, and that the selected image is an image for “self portrait” mode. In step S1012, the viewer 300 launches the “self portrait” application. However, the launching is unnecessary if the “self portrait” application is already running.

Next, in step S1013, the viewer 300 issues an acquisition request for a frame image (picture) to the cradle 200. While this request is ultimately a request to the camera 100, the request is mediated at the cradle 200 to be re-issued as a frame image acquisition request from the cradle 200 to the camera 100. In step S1014, the camera 100 sends back the requested frame image to the cradle 200, and in turn, the cradle 200 sends back the frame image to the application of the viewer 300. In this manner, in step S1015, the application of the viewer 300 receives and displays the image data.

Next, in step S1016, the application of the viewer 300 issues a request for a change to a photography mode of the camera 100. This request is similarly mediated by the cradle 200 and sent to the camera 100. In step S1017, the camera 100 changes to “capturing still image” mode. In step S1018, the application requests a finder image. A finder image is defined as a video, from which data has been thinned out, used to verify a subject prior to taking a picture. In step S1019, the camera 100 acquires a finder image, and in step S1020, sends back the finder image to the application of the viewer 300 via the cradle 200. In step S1021, the viewer 300 displays the finder image. The finder image may be consecutively and repeatedly requested, acquired, sent back, received, and displayed.

In addition, instructions for changing the parameters of the camera 100 are transmitted from the viewer 300 to the camera 100 according to a similar procedure to change settings. Once photography preparations have been concluded at the camera 100, in step S1022, a release request is transmitted from the application of the viewer 300 to the camera 100. In step S1023, the camera 100 photographs and acquires a picture. In step S1024, the photographed picture is sent back to the viewer 300. In step S1025, the viewer 300 receives the picture data. In step S1026, the received image is composited with an image such as a predetermined frame and displayed to complete a “self portrait” image. Finally, in step S1027, print out or storage and the like is performed.

In the above described embodiment, an application for self portrait is explained as an example, but the similar operation can be implemented in a video conference application. In this case, in a case that a camera which displays an image of a communication partner is set to a cradle, information indicating that the image is for the video conference, an ID or an address of the partner and a telephone number of the partner is sent to the viewer. The viewer then launches an application for the video conference and automatically connects with the communication partner. The information can be transmitted as the additional information 2 in FIG. 9B from the cradle to the viewer and can be embedded into a header of an image as in the self portrait application.

As the matter of fact, if the information is embedded in the header, then it is necessary to input several data after image capturing. In this case, the viewer can recognize a face in the image and identify the communication partner and acquire information of the partner. For example, the viewer launches an application for video conference in advance and the application has face information and a database for storing connection information. Then when the camera which displays an image of the communication partner is set to the cradle, the face image is sent to the viewer via the cradle. The viewer recognizes the face of the partner and identifies the partner, and then accesses to the database to acquire the connection information. Then the viewer automatically connects to the partner using the connection information. According to the embodiment, since the viewer holds the connection information and can recognize the face, the application of the video conference automatically connects to the partner without attaching any additional information to the image.

As described above, according to the fourth embodiment, operation modes of the cradle 200 and the viewer 300 may be controlled by connecting the cradle 200 with the camera 100 in a state in which an image is displayed on the camera 100. This enables automatic launch of applications corresponding to the image selected by the camera. As a result, troublesome application operations may be simplified, and a system with a high usability may be established.

### Fifth Embodiment

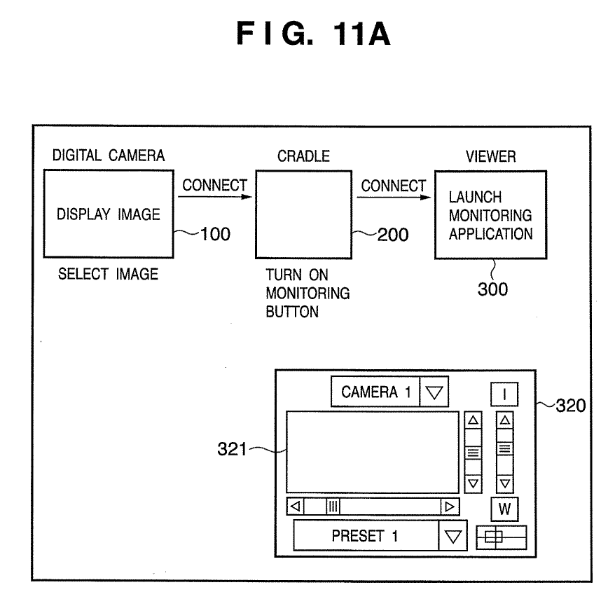

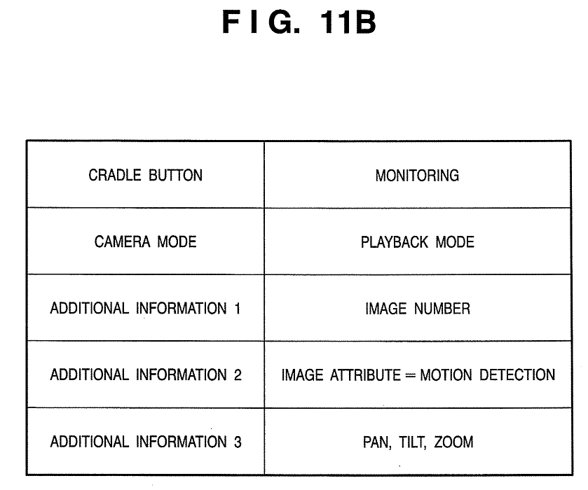

A fifth embodiment of the present invention will now be described. In the fifth embodiment, in a manner similar to the third embodiment, operations of the cradle 200 or applications may be controlled by connecting the camera 100 to the cradle 200 in a state in which a certain image is displayed on the camera 100 even with a “monitoring” application. For instance, in the first embodiment described earlier, assume that the camera 100 in “playback” mode is connected to the cradle 200 at which the application selection button 213 thereof is set to “monitoring”. This enables a “recorded image playback” mode to be launched on the viewer 300 as an operation of the “monitoring” application. For the fifth embodiment, as shown in FIG. 11, a description will be provided for a case where the camera 100, which is set to playback mode and in a state of displaying a certain image, is connected to the cradle 200.

FIG. 11A is a block diagram for explaining a software configuration of a camera system according to the fifth embodiment.

In the event that no application is selected for the cradle 200 in this state, the cradle 200 forwards a notification to the viewer 300 to the extent that the camera 100 has been connected, together with information of the selected image at the camera 100 as sub-information. In this case, the viewer 300 launches a conventional “file browsing” application, and displays the image selected by the camera 100. However, in the case where the “monitoring” application has been selected at the cradle 200, the “monitoring” application is launched in a recorded image display mode. In this case, assistance for search during recorded image display mode may be provided by, for instance, attaching information related to events in which images were recorded, such as input from a motion detection sensor or an external sensor.

Furthermore, the application may also be launched in live image monitoring mode instead of recorded image viewing mode. In this case, information related to pan, tilt and zoom at the time of recording may be used as information of the image selected by the camera 100 to control the cradle 200 to respective pan, tilt and zoom positions. This enables monitoring to commence from the same angle as the image selected by the camera 100. Such image information is preferably transmitted from the cradle 200 to the viewer 300 as information such as shown in FIG. 11B. A SOAP framework may be implemented for transmission of such information, as described earlier in the first embodiment.

FIG. 11B is a diagram for explaining information transmitted from the cradle 200 to the application of the viewer 300, according to the fifth embodiment.

In this example, the camera 100 is set to “playback” mode while “monitoring” is selected for the cradle 200. In this case, a “monitoring” application will be launched at the viewer 300 in a recorded image display mode. Additionally, information related to events (additional information 2) in which images were recorded, such as input from a motion detection sensor or an external sensor, will be attached as image attribute information. Furthermore, information related to pan, tilt and zoom at the time of recording will be attached as additional information 3.

A screen 320 represents an example of a screen to be displayed by the application of the viewer 300. In this example, an image from a “camera 1” in playback mode is displayed on a screen 321. Displays of scroll bars positioned around the screen 321 are changed according to information 3, or information related to pan, tilt and zoom, which is attached to the displayed image.

As described above, according to the fifth embodiment, operation modes for the cradle 200 and the viewer 300 may be controlled by connecting the camera 100 with the cradle 200 in a state in which an image is displayed on the camera 100. This enables an effect to be achieved in which monitoring is commenced from the same angle as the image selected by the camera 100, in addition to the effect achieved by the above-described fourth embodiment in which applications corresponding to the image selected at the camera 100 may be automatically launched.

In addition, a further effect may be achieved in which assistance for search during recorded image display mode may be provided by attaching information related to events in which images were recorded, such as input from a motion detection sensor or an external sensor.

In the present embodiment, a software program which implements the functions of the above-described embodiments is directly or remotely supplied to a system or an apparatus. The present invention also includes cases where the functions are achieved by reading out and executing the supplied program codes by a computer of the system or apparatus. In such cases, the program codes need not be in a form of a program, as long as they retain the functions of the program. Therefore, the program codes themselves, to be installed to a computer to enable the computer to achieve the functions and processing of the present invention, may also implement the present invention. In other words, the computer programs themselves for implementing the functions and processing of the present invention are also encompassed in the present invention. In such cases, as long as program functions are retained, the program may take any form, including an object code, an interpreter-executable program, or a script data supplied to an OS.

Storage devices for supplying the program include, for instance, a floppy disk (registered trademark), a hard disk, an optical dick, a magneto-optical disk, an MO, a CD-ROM, a CD-R, a CD-RW, a magnetic tape, a nonvolatile memory card, a ROM, a DVD (DVD-ROM, DVD-R) or the like. Other methods for supplying the program include cases where a browser of a client computer is used to connect to an Internet home page to download the computer program itself of the present invention from the home page. Alternatively, the program may be supplied by downloading a compressed file having an auto-install function to a storage media such as a hard disk. In addition, the present invention may also be achieved by dividing the program codes which configure the program of the present invention into a plurality of files, and downloading each file from a different home page. In other words, a WWW server which allows downloading of program files for achieving the functions and processing of the present invention on a computer by a plurality of users is also included in the scope of claims of the present invention.

In addition, the program of the present invention may be encoded and stored in a storage media such as a CD-ROM to be distributed to users. In this case, it is possible to have users who satisfy certain conditions download key information for decoding from a home page via the Internet, and use the key information to execute the encoded program to install the same on a computer in order to achieve the present invention.

The functions of the above-described embodiments may also be achieved by executing a read out program by a computer. In addition, the functions of the above-described embodiments may also be achieved by processing performed by an OS or the like running on a computer, wherein the OS or the like performs a portion of or all of the actual processing based on instructions of the program.

Furthermore, the program readout from the storage media is written into a memory provided on a function extension board inserted into a computer or a function extension unit connected to the computer. Subsequently, the functions of the above-described embodiments may also be achieved by processing performed by a CPU or the like provided on the function extension board or the function extension unit, wherein the CPU or the like performs a portion of or all of the actual processing based on instructions of the program.

As described above, according to the present embodiment, a desired application may be directly launched in a desired state by combining mode selection of the camera with application selection of the cradle. For instance, by turning on the camera when “photography” mode is selected and turning on the cradle when “monitoring” mode is selected, a “monitoring” application on an operation terminal of a computer or the like will be launched to commence reception of live images. In addition, by turning on a digital camera when “playback” mode is selected and turning on the cradle when “monitoring” mode is selected, monitoring software on the computer will be launched in “recording playback” mode. Such methods may be used to simplify operations related to applications.

Additionally, activation sequences may be arranged to respond to all activation sequences of the cradle and operation terminals. For instance, when the activation sequence is, from first to last, cradle, operation terminal, and camera, an application designated by the application selection at the cradle will be launched and set to a default initial state. Subsequently, when the digital camera is connected to the cradle, the state will change to a state designated by the digital camera.

Furthermore, application operations may be instructed using a specific image selected by the digital camera. For instance, when using a “self portrait” application, by connecting the digital camera to the cradle when the digital camera is in a state in which a frame image has been selected in advance, the selected image may be automatically set as a background frame when the “self portrait” application is launched on the computer. As a result, an effect is achieved in which a wide variety of convenient operation methods may be provided to users.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-278784, filed Sep. 26, 2005, which is hereby incorporated by reference herein in its entirety.

What is claimed is:

1. A cradle apparatus having a mount member for mounting an image sensing apparatus, a control unit for controlling the image sensing apparatus mounted on the mount member, and a communication unit for communicating with a terminal apparatus,
the cradle apparatus comprising:
a mode acquisition unit configured to acquire an operation mode of the image sensing apparatus; and
a notification unit configured to notify an operation mode of the image sensing apparatus acquired by said mode acquisition unit and information related to an application that is to be executed in a terminal apparatus, selected by the cradle apparatus, to the terminal apparatus.

2. The cradle apparatus according to claim 1, further comprising an attitude control unit configured to provide an attitude control of the image sensing apparatus mounted onto the mount member.

3. The cradle apparatus according to claim 1, wherein the control unit controls the image sensing apparatus in response to a control request from the terminal apparatus.

4. The cradle apparatus according to claim 1, further comprising:
an acquisition unit configured to acquire through the communication unit a state of an application running on the terminal apparatus; and
a setting unit configured to set an operation state of the cradle apparatus according to the state acquired by said acquisition unit.

5. The cradle apparatus according to claim 1, further comprising:
an acquisition unit configured to acquire through the communication means a state of an application running on the terminal apparatus; and
a setting unit configured to set an operation state of the cradle apparatus and the image sensing apparatus according to the state acquired by said acquisition unit.

6. A terminal apparatus for communicating with a cradle apparatus for mounting an image sensing apparatus, the terminal apparatus comprising:
a mode acquisition unit configured to acquire an operation mode of the image sensing apparatus from the cradle apparatus; and
a determination unit configured to determine an operation of an application to be executed, according to the operation mode acquired by said mode acquisition unit.

7. The terminal apparatus according to claim 6, wherein said mode acquisition unit acquires an operation mode of the cradle apparatus and/or the image sensing apparatus either upon an activation event at the cradle apparatus or upon connection of the image sensing apparatus to the cradle apparatus.

8. A camera control system having a camera, a cradle apparatus for mounting the camera, and a terminal apparatus which communicates with the cradle apparatus, the camera control system comprising:
an acquisition unit configured to acquire at the cradle apparatus an operation mode of a camera mounted on the cradle apparatus and information related to an application to be executed in a terminal apparatus, selected at the cradle apparatus;
a notification unit configured to notify the operation mode of the camera and the information acquired by said acquisition unit to the terminal apparatus; and
a launching unit configured to determine an operation of an application to be launched on the terminal apparatus and launch the application according to the operation mode of the camera mounted onto the cradle apparatus and the information notified by said notification unit.

9. A camera control system according to claim 8, wherein the application is a video conferencing application, the terminal apparatus having:
identification means for acquiring an image of a person captured by the camera and recognizing the image to identify the person; and
connection means for acquiring connection information of a terminal based on information of the person identified by said identification means and connecting with the terminal using the connection information.

10. A control method for a camera control system having a camera, a cradle apparatus for mounting the camera, and a terminal apparatus which communicates with the cradle apparatus, the control method comprising:
an acquisition step of acquiring at the cradle apparatus an operation mode of a camera mounted onto the cradle apparatus and information related to an application to be executed in a terminal apparatus, selected at the cradle apparatus;
a notification step of notifying the operation mode of the camera and the information acquired in said acquisition step, to the terminal apparatus; and
a launching step of determining an operation of an application to be launched on the terminal apparatus and launching the application according to the operation mode of the camera and the information notified in said notification step.

11. A control method of a terminal apparatus for communicating with a cradle apparatus for mounting an image sensing apparatus, the control method comprising:
an acquisition step of acquiring an operation mode of the image sensing apparatus from the cradle; and
a determination step of determining an operation of an application to be executed, according to the operation mode of the image sensing apparatus acquired in said acquisition step.

12. A computer readable storage media which stores a program for executing the control method according to claim 11.
